(19) United States
(12) Patent Application Publication
(10) Pub. No.: US 2022/0061329 A1
(43) Pub. Date: Mar. 3, 2022

(54) ANTIVIRAL SMARTPHONE COVER

(71) Applicant: INTERMAN Corporation, Kagoshima-shi (JP)

(72) Inventors: Shigeki UETABIRA, Kagoshima-shi (JP); Aruki UETABIRA, Kagoshima-shi (JP)

(73) Assignee: INTERMAN Corporation, Kagoshima-shi (JP)

(21) Appl. No.: 17/410,095

(22) Filed: Aug. 24, 2021

(30) Foreign Application Priority Data
Aug. 29, 2020 (JP) 2020-145112

(51) Int. Cl. A01N 59/20

(52) U.S. Cl. CPC A01N 59/20; H04M 1/17

(57) ABSTRACT

An antiviral smartphone cover with infection preventive function to prevent infection of pathogens such as virus, bacteria and the like. The antiviral smartphone cover is made of a non-woven fabric in which copper having an antiviral activity is incorporated, and capable of generating copper ions. The copper ions can inactivate any viruses settling on the surface of a smartphone. Preferably, the non-woven fabric is made of a polymeric material in which insoluble copper oxide fine particles are incorporated in fibers. The size of the copper oxide fine particles is preferably between 0.2 to 20.

### CROSS-REFERENCE TO RELATED APPLICATIONS

The present application claims priority under 35 U.S.C. § 119 to Japanese Patent Application No. P2020-145112, filed on Aug. 29, 2020 including description, claims, drawings, and abstract. The contents of this application are herein incorporated by reference in their entirety.

### FIELD

The present invention relates to an antiviral smartphone cover with infection preventive function to prevent infection of pathogens such as virus, bacteria and the like.

### BACKGROUND

The new coronavirus has occurred a pandemic and let people know how the densely populated, high-speed and volume transportation society in the 21st century is vulnerable to an infectious disease.

In such a situation, everything around us looks an infectious agent so that daily life becomes confining. In fact, it seems necessarily to doubt everything in an infection spread situation.

While it is important to take measures such as wearing a mask, keeping sufficient distances from others, avoiding all crowded spaces, it is inevitable to make minimum contact with an infection route for carrying out life in society. To minimize this risk as small as possible is vital for preventing infection.

One of infection routes which we should be careful of is routes via smartphones which are always carried by people. Actually, people frequently handle smartphones even during movement. In the case where a smartphone is operated just after touching a high touch surface such as a door knob, it is considered that virus attached to the smartphone remains for several days at longest with infectiousness.

However, it is difficult to diligently sterilize a smartphone with a disinfection liquid. Actually, there is the possibility that a disinfection liquid enters the inside of the smartphone to induce a failure. A case may be mounted on a smartphone as described in Japanese Unexamined Patent Application Publication No. 2020-065245. It is considered to sterilize this case in place of the smartphone itself. However, it is not realistic to always carry a disinfection liquid and sterilize the case every time. In addition to this, the smartphone itself may be infected.

Taking into consideration the above circumstances, it is an object of the present invention therefore to provide an antiviral smartphone cover capable of preventing infection of pathogens without need for troublesome disinfection operation.

### SUMMARY

To achieve at least one of the above-mentioned objects, reflecting one aspect of the present invention, an antiviral smartphone cover is made of a non-woven fabric in which copper having an antiviral activity is incorporated.

Also, in accordance with one embodiment of the antiviral smartphone cover, the non-woven fabric is made of a polymeric material in which insoluble copper oxide fine particles are incorporated in fibers.

Furthermore, in accordance with one embodiment of the present invention, it is preferred that the size of the copper oxide fine particles is between 0.2 to 20 microns.

Still further, in accordance with one embodiment of the present invention, the antiviral smartphone cover comprises: a main body made of the non-woven fabric for covering back and side surfaces of a smartphone, and a screen cover made of the non-woven fabric extending from the main body and capable of being folded to cover the screen of the smartphone.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a front view for showing an antiviral smartphone cover on which a smartphone is mounted in accordance with an embodiment 1 of the present invention.

FIG. 2 is a back view for showing the antiviral smartphone cover on which the smartphone is mounted in accordance with the embodiment 1 of the present invention.

FIG. 3 is a perspective view for explaining the operation of closing the antiviral smartphone cover, for example, when carrying the smartphone mounted on the antiviral smartphone cover 1.

FIG. 4 is a front view for showing the antiviral smartphone cover which is closed.

FIG. 5 is a back view for showing the antiviral smartphone cover which is closed.

FIG. 6 is a cross sectional view along A-A line of FIG. 4.

FIG. 7 is a front view for showing an antiviral smartphone cover in accordance with an embodiment 2.

FIG. 8 is a perspective view for explaining the procedure of mounting the smartphone on the antiviral smartphone cover in accordance with the embodiment 2.

FIG. 9 is a perspective view for showing the antiviral smartphone cover in accordance with the embodiment 2 on which the smartphone is mounted.

FIG. 10 is a front view for showing the antiviral smartphone cover 3 in accordance with an embodiment.

FIG. 11 is a back view for showing the antiviral smartphone cover 3 in accordance with the embodiment 3.

FIG. 12 is a perspective view for explaining the procedure of mounting the smartphone on the antiviral smartphone cover in accordance with the embodiment 3.

FIG. 13 is a perspective view for showing the antiviral smartphone cover in accordance with the embodiment 3 on which the smartphone is mounted with the screen cover being closed.

FIG. 14 is a front view for showing an antiviral smartphone cover in accordance with an embodiment 4.

FIG. 15 is a perspective view for explaining the procedure of mounting the smartphone on the antiviral smartphone cover in accordance with the embodiment 4.

FIG. 16 is a perspective view for showing the antiviral smartphone cover in accordance with the embodiment 4 on which the smartphone is mounted.

FIG. 17 is a perspective view for showing the antiviral smartphone cover in accordance with the embodiment 4 mounted on the smartphone as seen from the back side.

FIG. 18 is a perspective view for showing an antiviral smartphone cover in accordance with an embodiment 5 mounted on the smartphone.

FIG. 19 is a cross sectional view along A-A line of FIG. 18.

FIG. 20 is a perspective view showing an example that a screen cover is provided on the antiviral smartphone cover in accordance with the embodiment 5.

FIG. 21 is a perspective view showing a fastening hook with which an antiviral smartphone cover in accordance with an embodiment 6 is mounted on the smartphone.

FIG. 22 is a perspective view for showing the antiviral smartphone cover in accordance with the embodiment 6 which is mounted on the smartphone with the fastening hooks.

FIG. 23 is a perspective view for showing an exemplary modification of the antiviral smartphone cover in accordance with the embodiment 6.

FIG. 24 is a front view for showing an antiviral smartphone cover in accordance with an embodiment 7.

FIG. 25 is a back view for showing the antiviral smartphone cover 3 in accordance with the embodiment 7.

FIG. 26 is a front view for showing the antiviral smartphone cover in accordance with the embodiment 7 which is mounted on the smartphone.

FIG. 27 is a perspective view for explaining the procedure of mounting the smartphone on an antiviral smartphone cover in accordance with an embodiment 8.

FIG. 28 is a perspective view for showing the antiviral smartphone cover in accordance with the embodiment 8 which is mounted on the smartphone.

FIG. 29 is a cross sectional view along A-A line of FIG. 28.

### DETAILED DESCRIPTION

The present invention is related to an antiviral smartphone cover for covering a smartphone which is always carried by a user. The smartphone is frequently operated even just after touching an infectious agent so that it is desired to perform sterilization. Accordingly, the antiviral smartphone cover in accordance with the present invention is made of a copper oxide non-woven fabric. The copper oxide non-woven fabric can generate copper ions which can inactivate any viruses settling on the surface of a smartphone.

This copper oxide non-woven fabric is made of an antiviral polymeric material in which insoluble copper oxide fine particles are incorporated in fibers. Specifically describing, a polymeric raw material is prepared from any polymer, the chief raw material preferably being selected from a polyamide, a polyalkylene, a polyurethane and a polyester. The raw material is heated to melt at a temperature which preferably will range from about 80 to 150° C. Then, a water insoluble powder of cationic copper oxide is added to the melted material and allowed to spread through the melted material in the form of a liquid slurry. The particulate size of the spread cationic copper oxide will be preferably between 0.2 to 20 microns, however can be larger when the film or fiber thickness can accommodate larger particles. The liquid slurry is then pushed with pressure through holes in a series of metal plates formed into a circle called a spinneret to product a non-woven fabric. The details of this production method is described, for example, in PCT Published Japanese Translation No. 2008-534708.

The antiviral smartphone cover in accordance with the present invention can be used by mounting it on smartphones which are always carried by people, and even if virus is transferred to the surface of the smartphone, copper ions of the copper oxide non-woven fabric inactivate the virus to minimize the risk that the smartphone becomes an infectious agent.

Also, the copper ions generated from the antiviral smartphone cover in accordance with the present invention are effective to not only virus but also other types of pathogens such as bacteria and the like so that the antiviral smartphone cover is effective in preventing general infections.

### Embodiment 1

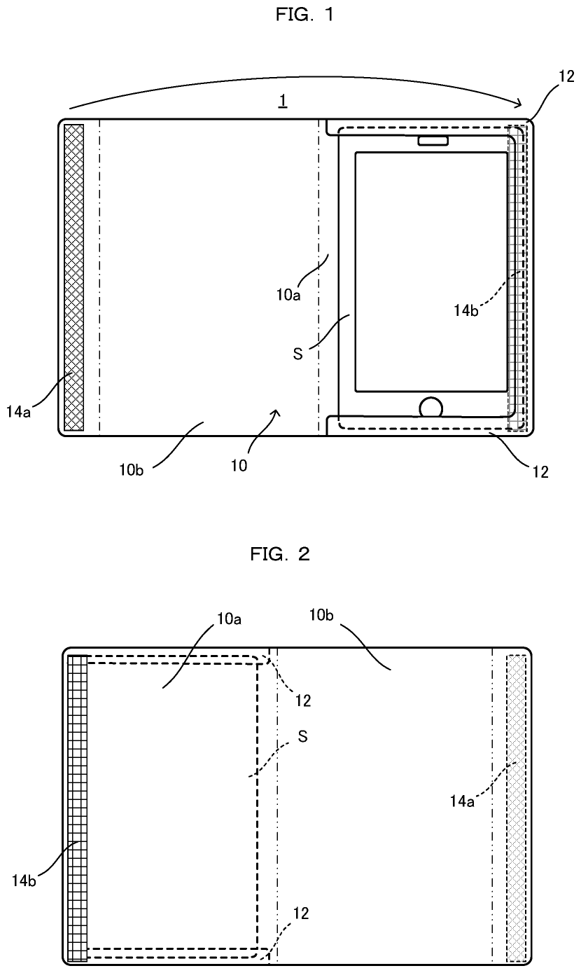

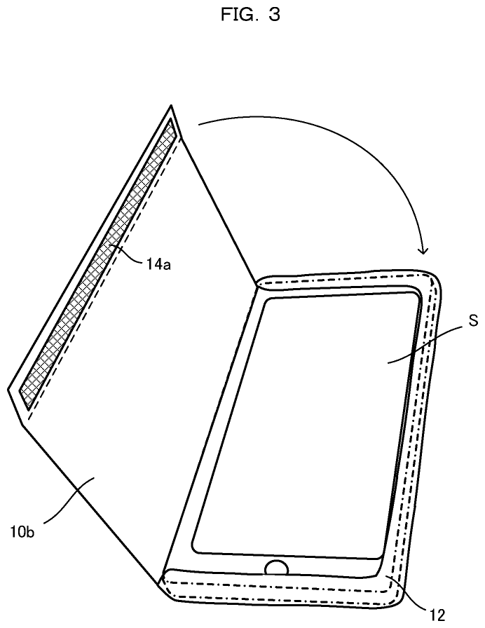

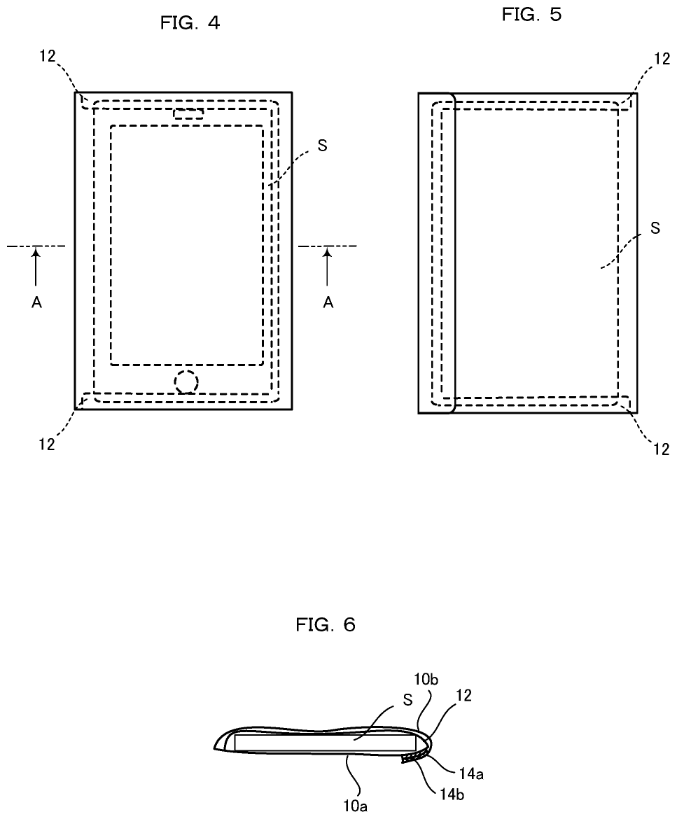

In what follows, an antiviral smartphone cover in accordance with an embodiment 1 of the present invention will be explained with reference to the accompanying drawings. FIG. 1 is a front view for showing the antiviral smartphone cover 1 on which a smartphone is placed in accordance with the embodiment 1 of the present invention. FIG. 2 is a back view for showing the antiviral smartphone cover 1 on which the smartphone is placed in accordance with the embodiment 1 of the present invention. FIG. 3 is a perspective view for explaining the operation of closing the antiviral smartphone cover 1, for example, when carrying the smartphone mounted on the antiviral smartphone cover 1. FIG. 4 is a front view for showing the antiviral smartphone cover 1 which is closed. FIG. 5 is a back view for showing the antiviral smartphone cover 1 which is closed. FIG. 6 is a cross sectional view along A-A line of FIG. 4.

As illustrated in the figures, the antiviral smartphone cover 1 includes a non-woven fabric main body 10, a locking frame 12 which is provided along upper, lower and right edges of the right half 10a of this non-woven fabric main body 10, a touch fastener 14a which is attached to the front side (inner surface) of the non-woven fabric main body 10 along the left edge of the non-woven fabric main body 10, and a touch fastener 14b which is attached to the back side (outer surface) along the right edge of the non-woven fabric main body 10 (along the left edge in the back view of FIG. 2). The locking frame 12 and the non-woven fabric main body 10 are made from the copper oxide non-woven fabric having antiviral feature as described above.

In this case, the touch fastener is known as a hook-and-loop fastener, a hook-and-pile fastener, velcro (registered trademark) and so forth consisting of a pair of female and male fasteners. For example, the touch fastener 14a is a female fastener, and the other touch fastener 14b is a male fastener. The male fastener features tiny hooks; the second features smaller loops. When the two are pressed together the hooks catch in the loops and the two pieces fasten or bind temporarily.

When this antiviral smartphone cover 1 is used, as illustrated in FIG. 1, the smartphone S is inserted from the left into the locking frame 12 provided in the right half of the non-woven fabric main body 10 to mount the smartphone S on the antiviral smartphone cover 1. Next, as illustrated in FIG. 3, the left half 10b of the non-woven fabric main body 10 is folded to cover the surface (screen) of the smartphone S. Then, as illustrated in FIG. 6, the touch fastener 14a extending beyond the right edge of the smartphone S is further folded to engage with the touch fastener 14b provided on the back surface of the non-woven fabric main body 10.

The smartphone S is usually carried in the state shown in FIG. 4 through FIG. 6. When the smartphone S is used, the user takes the smartphone S mounted on the antiviral smartphone cover 1 from a pocket or the like, separates the touch fasteners 14a and 14b, and opens the antiviral smartphone cover 1 to perform desired operation as illustrated in FIG. 1. After completing the desired operation, the antiviral smartphone cover 1 is closed as illustrated in FIG. 5, followed by keeping the smartphone S in a pocket or a bag. Namely, the left half 10b of the non-woven fabric main body 10 serves as a screen cover for protecting the screen of the smartphone S.

While the user may touch a variety of infectious agents, even if virus is transferred to the surface of a smartphone from a finger, copper ions of the antiviral smartphone cover 1 inactivate the virus. Furthermore, since the user touches the antiviral smartphone cover 1 with fingers, the virus on the fingers are inactivated by copper ions generated from copper oxide. Even in the case where the virus on the fingers is transferred to the screen of the smartphone S during operation, the copper oxide non-woven fabric comes in contact with the screen of the smartphone S, when the antiviral smartphone cover 1 is closed as illustrated in FIG. 5, to inactivate the virus. Accordingly, the smartphone S will not become an infection route.

### Embodiment 2

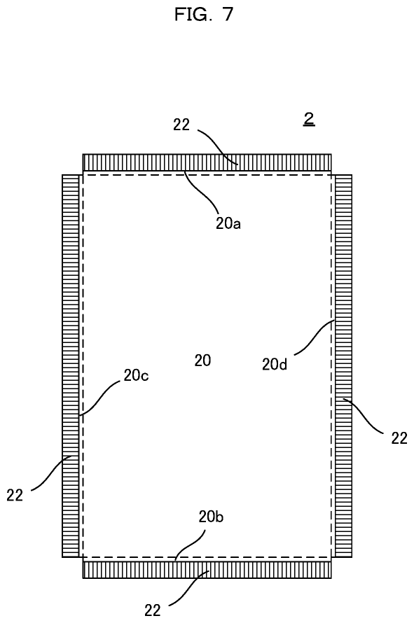

Next, an antiviral smartphone cover in accordance with an embodiment 2 of the present invention will be explained with reference to the accompanying drawings. FIG. 7 is a front view for showing the antiviral smartphone cover 2 in accordance with the embodiment 2.

This antiviral smartphone cover 2 consists of a rectangular section 20 having substantially the same size as a smartphone to be mounted on the antiviral smartphone cover 2, and edge sections 20a, 20b, 20c and 20d extending from the rectangular section 20 in the left, right, top and bottom directions. The rectangular section 20 and the edge sections 20a, 20b, 20c and 20d are made from the copper oxide non-woven fabric having antiviral feature as described above.

In addition to this, the edge sections 20a, 20b, 20c and 20d are provided with a double-sided adhesive tape 22 respectively. The surface of of the double-sided adhesive tape 22 is protected with a release paper in advance of using the antiviral smartphone cover 2.

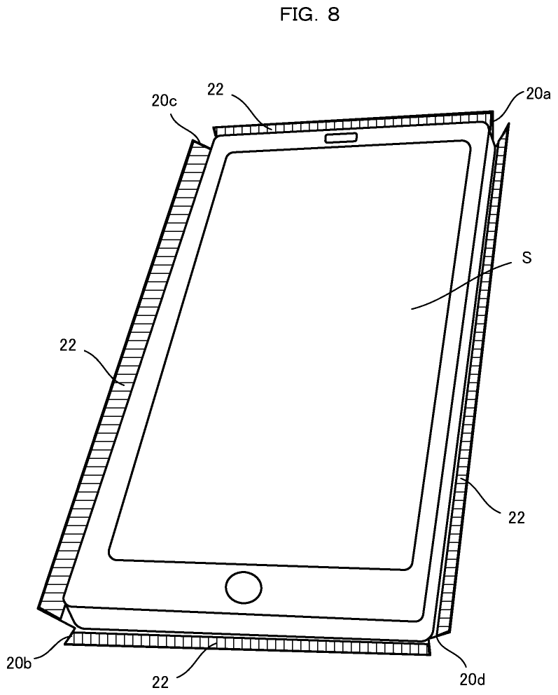

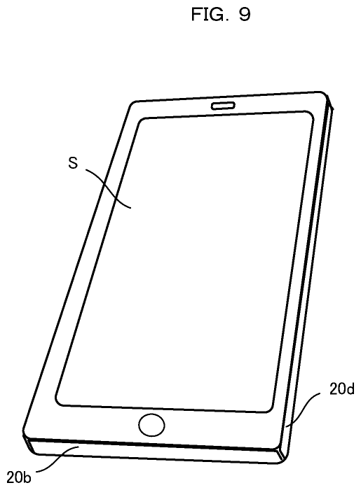

As illustrated in FIG. 8, when this antiviral smartphone cover 2 is used, the back face of the smartphone S is mounted on the rectangular section 20, and the edge sections 20a, 20b, 20c and 20d are folded toward the side surfaces of the smartphone S respectively. Then, after the release paper protecting the surface of the double-sided adhesive tape 22 is peeled off, the edge sections 20a, 20b, 20c and 20d are firmly attached to the side surfaces of the smartphone S as illustrated in FIG. 9. The back and side surfaces of the smartphone S are covered with the antiviral smartphone cover 2 made of the copper oxide non-woven fabric so that virus attached respectively to the surfaces can be inactivated.

Incidentally, the double-sided adhesive tape 22 is made, for example, of an acrylic adhesive. In the case of the acrylic adhesive, it is possible to control adhesive properties such as adhesive force, repeeling property or the like by selecting a monomer type, the molecular weight of polymer, a crosslinking density or the like. The smartphone S are always taken in and out for use with frequency, so that the antiviral smartphone cover will be exchanged due to deterioration thereof. Accordingly, the adhesive properties are adjusted in order that there is no residual adhesive left on the side surface after peeling off the double-sided adhesive tape 22. Meanwhile, a silicone adhesive can be used in place of the acrylic adhesive.

### Embodiment 3

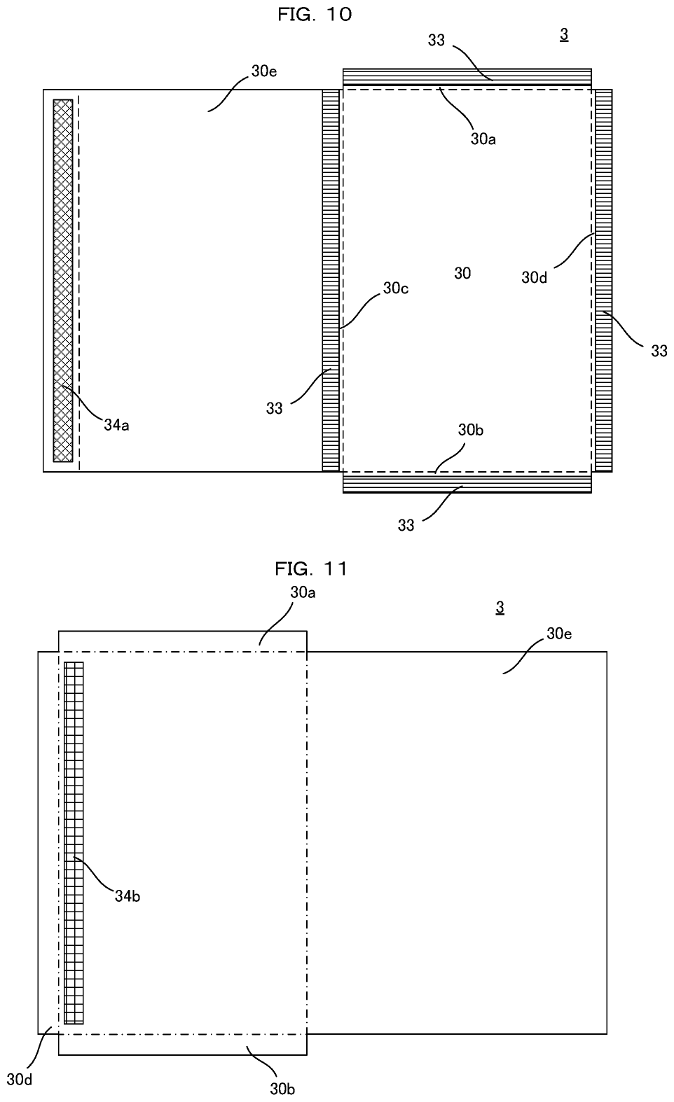

Next, an antiviral smartphone cover in accordance with an embodiment 3 of the present invention will be explained with reference to the accompanying drawings. FIG. 10 is a front view for showing the antiviral smartphone cover 3 in accordance with the embodiment 3. FIG. 11 is a back view for showing the antiviral smartphone cover 3 in accordance with the embodiment 3.

This antiviral smartphone cover 3 is such that the antiviral smartphone cover 2 of the embodiment 2 is provided with the screen cover of the embodiment 1 (the left half 10b of the non-woven fabric main body 10). Namely, the antiviral smartphone cover 3 includes a rectangular section 30 having the same size as a smartphone to be mounted on the antiviral smartphone cover 2, and edge sections 30a, 30b, 30c and 30d extending from the rectangular section 30 in the left, right, top and bottom directions.

Likewise, the edge sections 30a, 30b, 30c and 30d are provided with a double-sided adhesive tape 33 respectively. The surface of of the double-sided adhesive tape 33 is protected with a release paper in advance of using the antiviral smartphone cover 3.

In addition to this, the edge sections 30c at the left edge of the rectangular section 30 further extends therefrom as a screen cover 30e. Furthermore, a touch fastener 34a is provided along the left edge of the screen cover 30e, and a touch fastener 34b is provided on the back side (outer surface) along the right edge of the rectangular section 30 (along the left edge in the back view of FIG. 11).

Also, the rectangular section 30, the edge sections 30a, 30b, 30c and 30d and the screen cover 30e are made from the copper oxide non-woven fabric having antiviral feature as described above. In the same manner as the embodiment 1, one of the touch fasteners 34a and 34b is a female fastener, and the other is a male fastener.

Like the embodiment 2 shown in FIG. 8, when this antiviral smartphone cover 3 is used, the back face of the smartphone S is mounted on the rectangular section 30, and the edge sections 30a, 30b, 30c and 30d are folded toward the side surfaces of the smartphone S respectively. Then, after the release paper protecting the surface of the double-sided adhesive tape 33 is peeled off, the edge sections 30a, 30b, 30c and 30d are firmly attached to the side surfaces of of the smartphone S as illustrated in FIG. 12.

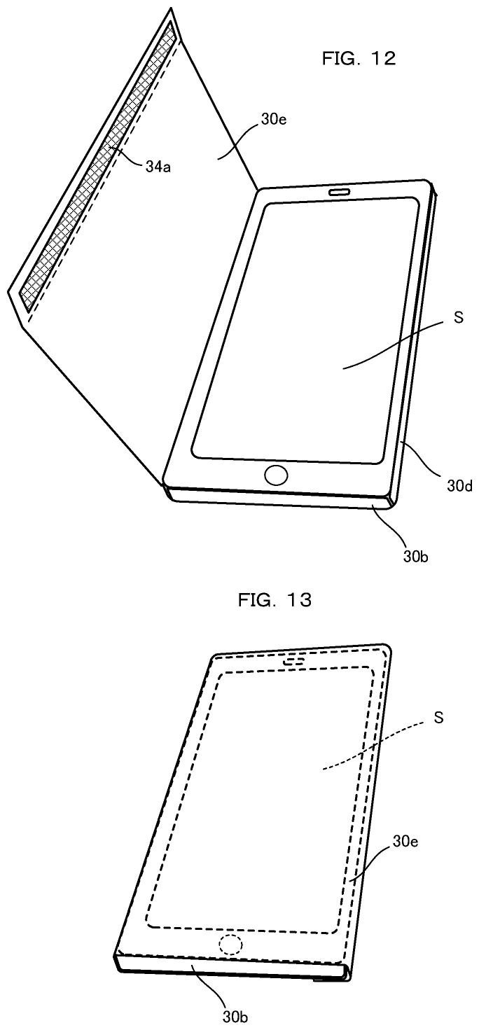

Furthermore, the screen cover 30e is folded to the right to cover the screen of the smartphone S. Then, like the screen cover 10b of the embodiment 1, the touch fastener 34a extending beyond the right edge of the smartphone S is further folded to engage with the touch fastener 34b provided on the back surface of the rectangular section 30 (refer to FIG. 13). The whole surfaces of the smartphone S are covered with the antiviral smartphone cover 3 made of the copper oxide non-woven fabric so that virus attached to the surfaces can be inactivated.

The smartphone S is usually carried in the state shown in FIG. 13. When the smartphone S is used, the user takes the smartphone S mounted on the antiviral smartphone cover 3 from a pocket or the like, separates the touch fasteners 34a and 34b, and opens the screen cover 30e to perform desired operation as illustrated in FIG. 12. After completing the desired operation, the antiviral smartphone cover 3 is closed as illustrated in FIG. 13, followed by keeping the smartphone S in a pocket or a bag. Accordingly, in the same manner as the embodiment 1, even if the virus is attached to the screen or surfaces of the smartphone S during operation, copper ions of the antiviral smartphone cover 3 inactivate the virus so that the smartphone S will not become an infection route.

### Embodiment 4

There are cases for smartphone having no back portion to cover only the circumferential edge of the smartphone. This kind of case may be referred to a bumper for absorbing impact in a collision on a corner or side. Most of such cases are made from a material having elasticity, and just fitted to the circumferential edge of the smartphone to run therearound. In the case of the embodiment 4, an antiviral smartphone cover made from the copper oxide non-woven fabric having antiviral feature as described above is held by this bumper (case).

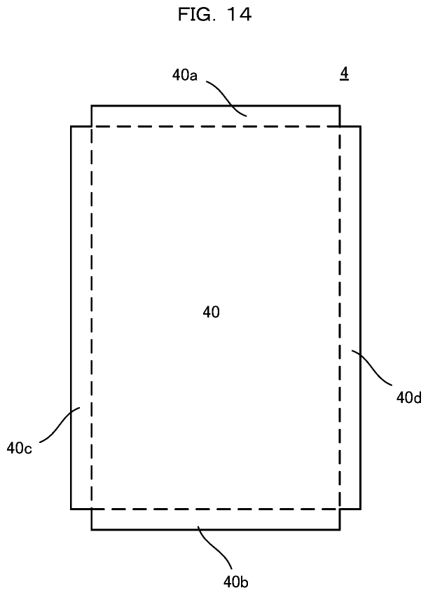

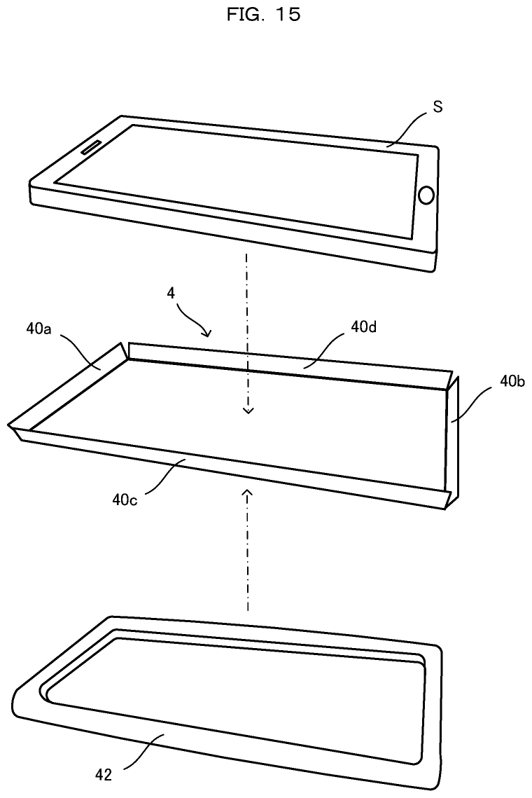

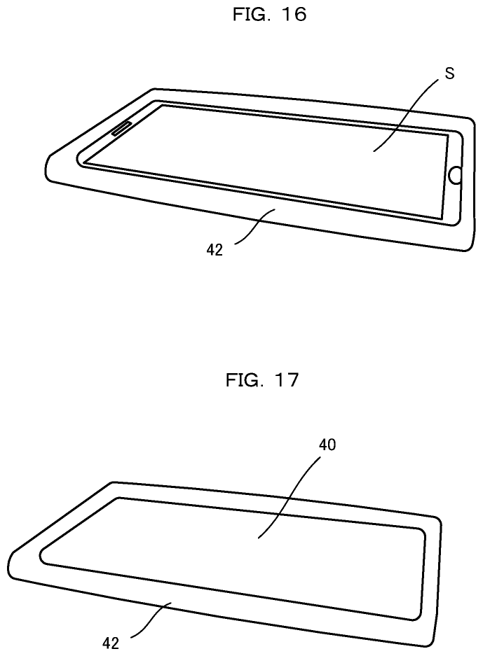

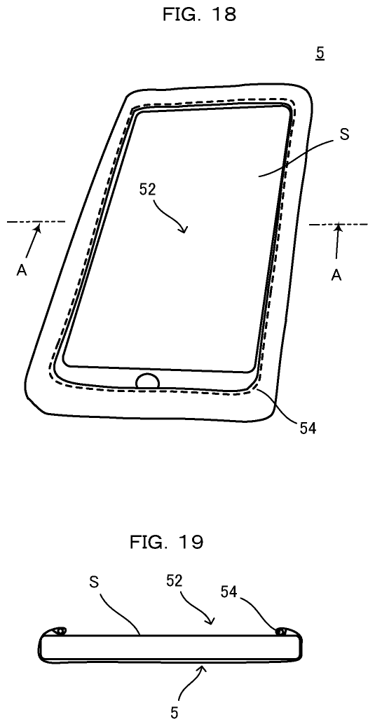

FIG. 14 is a front view for showing an antiviral smartphone cover 4 in accordance with the embodiment 4. FIG. 15 is a perspective view for showing the way of mounting the antiviral smartphone cover 4 in accordance with the embodiment 4 on the smartphone S. FIG. 16 is a perspective view for showing the antiviral smartphone cover 4 in accordance with the embodiment 4 mounted on the smartphone S. FIG. 17 is a perspective view for showing the antiviral smartphone cover 4 in accordance with the embodiment 4 mounted on the smartphone S as seen from the back side.

This antiviral smartphone cover 4 consists of a rectangular section 40 having substantially the same size as a smartphone to be mounted on the antiviral smartphone cover 4, and edge sections 40a, 40b, 40c and 40d extending from the rectangular section 40 in the left, right, top and bottom directions. The rectangular section 40 and the edge sections 40a, 40b, 40c and 40d are made from the copper oxide non-woven fabric having antiviral feature as described above.

The antivirus cover 4 in accordance with the embodiment 4 has a substantially same configuration as the antiviral smartphone cover 2 in accordance with the embodiment 2 as illustrated in FIG. 7, but is provided with no double-sided adhesive tape. When mounting the bumper on the circumferential edge of the smartphone, the antiviral smartphone cover 4 is fixed to the smartphone by holding the edge sections 40a, 40b, 40c and 40d between the bumper and the circumferential edge of the smartphone.

Namely, when this antiviral smartphone cover 4 is used, the back face of the smartphone S is mounted on the rectangular section 40, and the edge sections 40a, 40b, 40c and 40d are folded toward the side surfaces of the smartphone S respectively. Then, the bumper(case) 42 is mounted on the circumferential edge of the smartphone to pinch the edge sections 40a, 40b, 40c and 40d between the bumper and the circumferential edge of the smartphone S. The back surface of the smartphone S is covered with the antiviral smartphone cover 4 made of the copper oxide non-woven fabric so that virus attached respectively to the surfaces can be inactivated.

### Embodiment 5

Next, an antiviral smartphone cover in accordance with an embodiment 5 of the present invention will be explained with reference to the accompanying drawings. FIG. 18 is a perspective view for showing the antiviral smartphone cover 5 in accordance with the embodiment 5 mounted on the smartphone S. FIG. 19 is a cross sectional view along A-A line of FIG. 18.

This antiviral smartphone cover 5 is of a sack-like flat form having a large opening 52 and made from the copper oxide non-woven fabric having antiviral feature as described above. A loop of rubber 54 is inserted into a passage formed on the edge of the opening 52 to urge the opening 52 to close. This rubber loop 54 urges the opening 52 to close so that the antiviral smartphone cover 5 is prevented from being disengaged from the smartphone S.

The back and side surfaces of the smartphone S are then covered with the antiviral smartphone cover 5 made of the copper oxide non-woven fabric so that virus attached respectively to the surfaces can be inactivated.

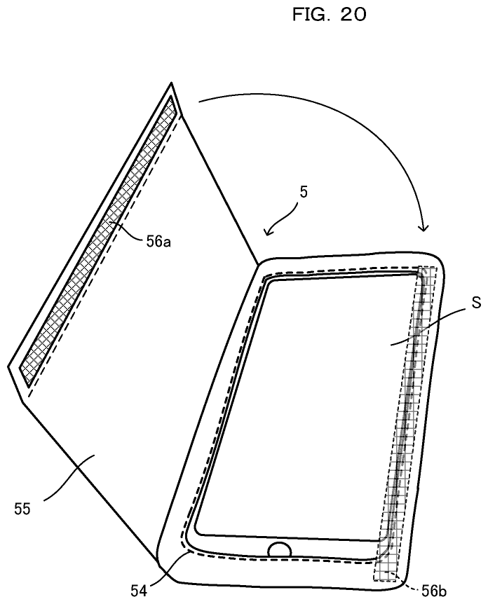

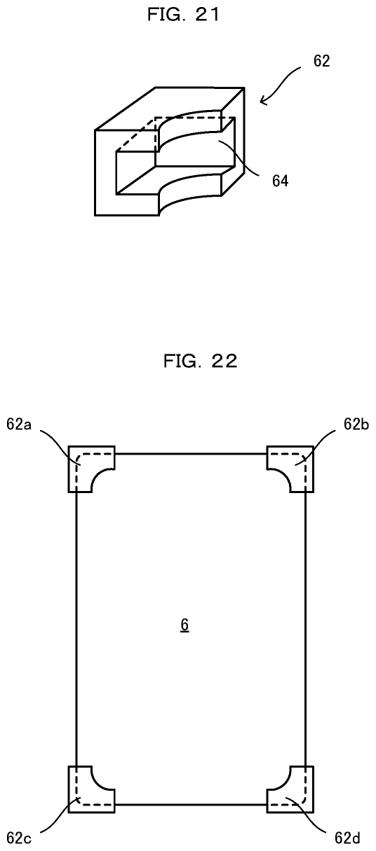

Alternatively, as illustrated in FIG. 20, a screen cover 55 can be provided in the same manner as in the embodiment 3. This screen cover 55 is attached to the left edge of the antiviral smartphone cover 5. Also, a touch fastener 56a is provided on the inside of the distal end of the screen cover 55, and a touch fastener 56b corresponding to the touch fastener 56a is provided on the back side of the right side of the antiviral smartphone cover 5. In the same manner as in the embodiment 1, the entirety of the smartphone S can be enclosed with the copper oxide non-woven fabric by closing the screen cover 55 and engaging the touch fasteners 56a and 56b.

In this case, even if the virus is attached to the screen or surfaces of the smartphone S, copper ions of the antiviral smartphone cover 5 inactivate the virus so that the smartphone S will not become an infection route.

### Embodiment 6

Next, an antiviral smartphone cover in accordance with an embodiment 6 of the present invention will be explained with reference to the accompanying drawings. The antiviral smartphone cover of this embodiment 6 consists of a single copper oxide non-woven fabric sheet having antiviral feature as described above and the same size and shape (approximately rectangle) as a smartphone to be mounted on this copper oxide non-woven fabric sheet.

In order to fix this antiviral smartphone cover to the smartphone, a fastening hook 62 as shown in FIG. 21 is used. This fastening hook 62 is made of a resin approximately in the form of a cuboid having an engaging groove 64 whose height is same as the thickness of the smartphone in order that the corner of the smartphone can be just fitted to and engaged with the engaging groove 64.

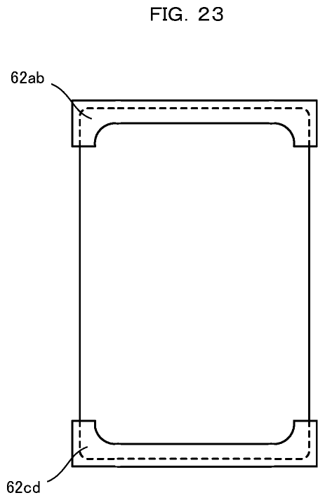

When this antiviral smartphone cover is mounted on the smartphone, as illustrated in FIG. 22, the four corners of the smartphone with the antiviral smartphone cover 6 mounted thereon are slid respectively into the engaging grooves 64 of four fastening hooks 62 (62a, 62b, 62c and 62d) to fix the antiviral smartphone cover 6 to the back surface of the smartphone. The back surface of the smartphone is covered with the antiviral smartphone cover 6 made of the copper oxide non-woven fabric so that virus attached respectively to the surfaces can be inactivated.

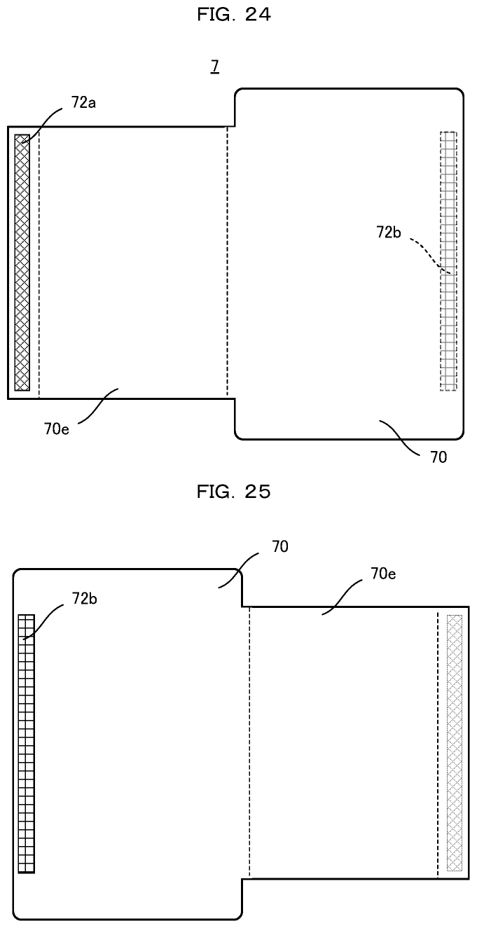

Incidentally, the upper right and upper left fastening hooks 62a and 62b may be inwardly extended and united to be a fastening hook 62ab as illustrated in FIG. 23. Also, the lower right and lower left fastening hooks 62c and 62d may be inwardly extended and united to be a fastening hook 62cd as illustrated in FIG. 23.

### Embodiment 7

Next, an antiviral smartphone cover in accordance with an embodiment 7 of the present invention will be explained with reference to the accompanying drawings. Also in this embodiment 7, the fastening hooks 62a, 62b, 62c and 62d (or 62ab and 62cd) are used. However, as illustrated in FIG. 24, the antiviral smartphone cover 7 of this embodiment 7 consists of a rectangular section 70 having substantially the same size as a smartphone to be mounted on the antiviral smartphone cover 7, and a screen cover 70e extending from the left edge of the rectangular section 70. The rectangular section 70 and the screen cover 70e are made of a single copper oxide non-woven fabric sheet having antiviral feature as described above.

Furthermore, a touch fastener 72a is provided along the left edge of the screen cover 70e, and a touch fastener 72b is provided on the back side (outer surface) along the right edge of the rectangular section 70 (along the left edge in the back view of FIG. 25).

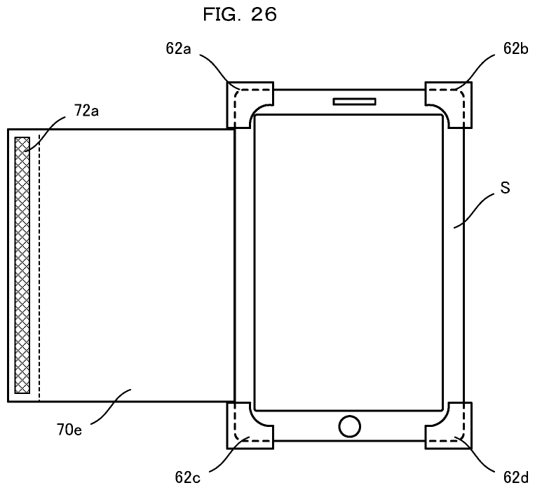

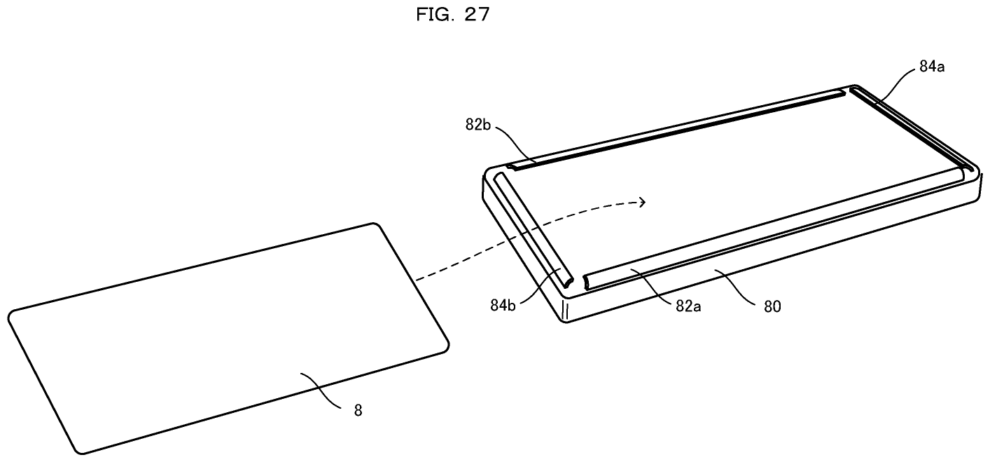

The rectangular section 70 of the antiviral smartphone cover 7 is fixed to the back surface of the smartphone with the fastening hooks 62a, 62b, 62c and 62d (or 62ab and 62cd) in the same manner as in the embodiment 6, while the screen cover 70e is extending to the left as illustrated in FIG. 26. When this smartphone S is not used, the screen cover 70e is fastened with the touch fasteners 72a and 72b to cover the screen of the smartphone S in the same manner as in the embodiment 3 shown in FIG. 12 and FIG. 13 Accordingly, like the embodiment 3, even if the virus is attached to the screen or surfaces of the smartphone S, copper ions of the antiviral smartphone cover 7 inactivate the virus.

### Embodiment 8

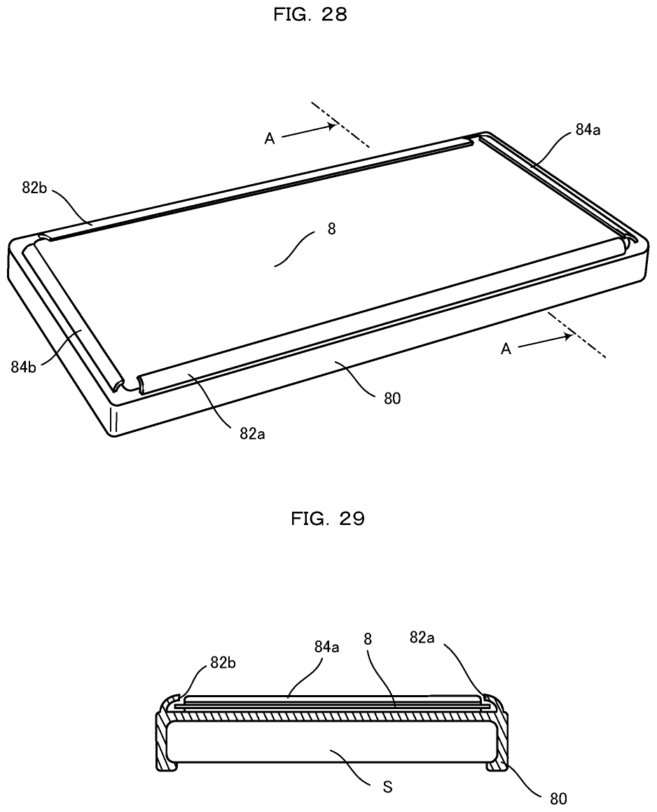

Next, an antiviral smartphone cover in accordance with an embodiment 8 of the present invention will be explained with reference to the accompanying drawings. FIG. 27 is a perspective view for explaining the procedure of mounting the smartphone S on the antiviral smartphone cover 8 in accordance with the embodiment 8. FIG. 28 is a perspective view for showing the antiviral smartphone cover 8 in accordance with the embodiment 8 mounted on the smartphone S. FIG. 29 is a cross sectional view along A-A line of FIG. 28.

The antiviral smartphone cover of this embodiment 8 consists of a single copper oxide non-woven fabric sheet having antiviral feature as described above and the slightly smaller size and shape (approximately rectangle) than the smartphone S to be covered with this copper oxide non-woven fabric sheet. In order to hold this antiviral smartphone cover 8, the smartphone S is mounted on a smartphone case 80 which is provided with right and left rail members 82a and 82b and upper and lower stopper 84a and 84b.

Namely, as illustrated in FIG. 27, the antiviral smartphone cover 8 can be mounted on the back face of the smartphone case 80 by sliding the antiviral smartphone cover 8 along the right and left rail members 82a and 82b. When the antiviral smartphone cover 8 is mounted on the back face of the smartphone case 80, the upper and lower stopper 84a and 84b prevent the antiviral smartphone cover 8 from coming off the smartphone case 80. The size of the antiviral smartphone cover 8 has been determined in accordance with the distance between the right and left rail members 82a and 82b and the distance between the upper and lower stopper 84a and 84b.

Namely, the distance between the right and left rail members 82a and 82b is determined to be larger than the width of the antiviral smartphone cover 8 only with a small difference of 1 mm or thereabout. On the other hand, the distance between the upper and lower stopper 84a and 84b is preferably determined to have a more margin so that the antiviral smartphone cover 8 can easily be mounted. For example, the distance between the upper and lower stopper 84a and 84b is determined to be wider than the length of the antiviral smartphone cover 8 by 2 mm through 4 mm or thereabout. While the antiviral smartphone cover 8 can slide in the longitudinal direction, it is held by the right and left rail members 82a and therefore shall not come off the smartphone case 80.

Accordingly, the back side of the smartphone S is covered with the antiviral smartphone cover 8 made of the copper oxide non-woven fabric so that virus attached respectively to the back side can be inactivated. This antiviral smartphone cover 8 can easily be exchanged as a consumable.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

While the smartphone S is used in the above description to explain the embodiments 1, 2, 3, 5, 6 and 7, the description is true even if the smartphone S is replaced with a smartphone mounted on an arbitrary smartphone case. For example, in the case of the embodiment 1, a smartphone mounted on an arbitrary smartphone case can be mounted on the antiviral smartphone cover 1 as described above. In this case, the size of the antiviral smartphone cover 1 is such as to accommodate the smartphone case.

Likewise, while the smartphone S is mounted on a smartphone case 80 provided with the right and left rail members 82a and 82b and the upper and lower stopper 84a and 84b in the case of the embodiment 8, it is possible not to use such a smartphone case and provide the right and left rail members 82a and 82b and the upper and lower stopper 84a and 84b on the smartphone itself.

What is claimed is:

1. An antiviral smartphone cover made of a non-woven fabric in which copper having an antiviral activity is incorporated.

2. The antiviral smartphone cover of claim 1, wherein the non-woven fabric is made of a polymeric material in which insoluble copper oxide fine particles are incorporated in fibers.

3. The antiviral smartphone cover of claim 2, wherein the size of the copper oxide fine particles is between 0.2 to 20 microns.

4. The antiviral smartphone cover of claim 1, comprising:
a main body made of the non-woven fabric for covering back and side surfaces of a smartphone; and
a screen cover made of the non-woven fabric extending from the main body and capable of being folded to cover the screen of the smartphone.
